(19) United States
(12) Patent Application Publication
(10) Pub. No.: US 2018/0181100 A1
(43) Pub. Date: Jun. 28, 2018

(54) NUMERICAL CONTROLLER

(71) Applicant: FANUC CORPORATION, Minamitsuru-gun (JP)

(72) Inventor: Yuuki Oonishi, Minamitsuru-gun (JP)

(73) Assignee: FANUC CORPORATION, Minamitsuru-gun (JP)

(21) Appl. No.: 15/845,099

(22) Filed: Dec. 18, 2017

(30) Foreign Application Priority Data
Dec. 22, 2016 (JP) 2016-250027

(51) Int. Cl. G05B 19/19; G05B 19/404; G05B 19/18; G05B 19/408

(52) U.S. Cl. CPC G05B 19/19; G05B 19/404; G05B 2219/35; G05B 19/4083; G05B 19/182

(57) ABSTRACT

A numerical controller drives, through pressure control, two motors which drives two tables of a driving apparatus while keeping these two tables parallel with each other. When there is a positional deviation between the two motors, the numerical controller calculates a correcting pressure based on correction gains indicating relationships between pressure and position stored in advance and corrects pressure command values of the two motors based on the correcting pressure.

### BACKGROUND OF THE INVENTION

### 1. Field of the Invention

The present invention relates to a numerical controller, and particularly, to a numerical controller that keeps multi-motor-driven tables parallel and drives the tables based on pressure control.

### 2. Description of the Related Art

A drive apparatus that uses a plurality of motors to drive tables is known. For example, in a press working apparatus and the like of recent years, a system of the mainstream uses a plurality of motors to drive tables to press a workpiece in order to generate pressure enough to press the workpiece. FIG. 1 shows an example of such a press working apparatus.

An upper die 11 and a lower die 21 are provided between an upper table 10 and a lower table 20 connected through ball screws, and a workpiece 30 is arranged between the dies 11 and 21. The upper table 10 is driven in a Z direction by a plurality of motors (first motor M1 and second motor M2 here), and the dies 11 and 21 press the workpiece 30. The motors M1 and M2 installed on the upper table 10 are connected to ball screws 51 and 52 through belts 41 and 42, and the load in the Z direction is generated by the driving force of the motors M1 and M2 and the weight of the motors M1 and M2.

Control systems of the drive apparatus, such as a press working apparatus, include position control and pressure control. In the position control, the positions of the tables are detected, and the positions are fed back to control the press. In the pressure control, a force sensor detects the external force applied to the tables and feeds back the external force to control the press. FIGS. 2A and 2B show characteristics of the two control systems.

As shown in FIG. 2A, although the displacement of position with respective to time can be commanded in the position control, the change in the pressure cannot be controlled in the meantime. In other words, although the position is reproducible, there is a variation in the reproducibility of the pressure. Therefore, the pressure on the workpiece may overshoot, that is, too much pressure may be applied. The overshoot leads to poor quality of a product.

As shown in FIG. 2B, although the change in pressure with respect to time can be commanded in the pressure control, the change in the position cannot be controlled in the meantime. In other words, although the pressure is reproducible, there is a variation in the reproducibility of the position. The overshoot is unlikely to occur in the pressure control. After all, the press working is processing with external force. Therefore, the quality of the product is constant when the external force, that is, the pressure, is controlled, instead of controlling the position. Therefore, the quality of the product is generally better in the pressure control.

However, in case of pressure control, the control is not based on the position. Therefore, when the tables are driven by a plurality of motors, there is a problem that the positions of the motors may be deviated, and the upper table may be inclined. When the position control is performed, the tables can be pushed down while the parallel state of the tables is maintained, even when the plurality of motors drive the tables.

In case of pressure control, on the other hand, the positions of the motors depend on the pressure. Therefore, the tables may not be evenly driven, and as a result, the upper table may be inclined. If the upper table and the lower table are not parallel, the products may be adversely affected; for example, machining failure rate of the products may rise, or lifetime of dies may be reduced. FIGS. 3A and 3B show a typical case in which the upper table is inclined in the pressure control.

When the installation position of the workpiece 30 is close to the edges of the tables 10 and 20 as shown in FIG. 3A or when the workpiece 30 has a shape that is easily inclined, such as an upper surface that is not horizontal, as shown in FIG. 3B, the parallel state of the tables 10 and 20 is unlikely to be maintained.

Japanese Patent Application Laid-Open No. 2015-205474 discloses an apparatus which is provided, on each ram axis, with an interval sensor that measures an interval between a movable die and a fixed die and issues a position command to a servomotor to control the servomotor to eliminate the inclination of the movable die relative to the ram axis.

Japanese Patent Application Laid-Open No. 2009-226451 discloses an apparatus which is configured to eliminate the inclination of a slide, wherein when a difference in load is detected between the left and right sides of the slide, the apparatus issues position commands to left and right servomotors to control the rotational speeds thereof to eliminate the inclination of the slide.

Japanese Patent Application Laid-Open No. 2003-230996 discloses an apparatus that corrects position commands to make uniform the position deviations of a plurality of servo axes, that is, deviations between target positions and position feedback values, to thereby prevent the inclination of the table.

However, each of the techniques described in the three patent documents premises on position control, and any of these techniques cannot be applied to pressure control. In addition, the technique described in Japanese Patent Application Laid-Open No. 2015-205474 has a problem that interval sensors need to be newly provided. Furthermore, Japanese Patent Application Laid-Open No. 2015-205474 and Japanese Patent Application Laid-Open No. 2009-226451 do not specifically disclose how to calculate an amount of movement or a gain which is to be delivered to a servomotor for eliminating an inclination of a table.

### SUMMARY OF THE INVENTION

The present invention has been made to solve the above-mentioned problems, and an object of the present invention is to provide a numerical controller that can drive multi-motor-driven tables based on pressure control while keeping the tables parallel.

A numerical controller according to the present invention controls a drive apparatus including a table driven by at least two motors, a first motor and a second motor. The numerical controller includes: a state detection unit that detects respective positions of the first motor and the second motor; a correction gain storage unit that stores, for each of the first motor and the second motor, a correction gain indicating a relationship between pressure and position; and a correction command unit that calculates, when the positions of the first motor and the second motor are deviated, a correcting pressure based on the correction gains to correct a pressure command values of each of the first motor and the second motor based on the correcting pressure.

The numerical controller may further include a correction gain calculation unit that calculates the correction gains.

When the position of the second motor advances more in a driving direction than the position of the first motor, the correction command unit may make a correction by increasing the pressure command value of the first motor and reducing the pressure command value of the second motor.

When the position of the second motor advances more in the driving direction than the position of the first motor, the correction command unit may make a correction by increasing only the pressure command value of the first motor and keeping the pressure command value of the second motor.

When the position of the second motor advances more in the driving direction than the position of the first motor, the correction command unit may make a correction by keeping the pressure command value of the first motor and reducing only the pressure command value of the second motor.

According to the present invention, a numerical controller can be provided that can drive multi-motor-driven tables based on pressure control while keeping the tables parallel.

### BRIEF DESCRIPTION OF THE DRAWINGS

FIG. 1 is a diagram showing an example of a conventional press working apparatus;

FIGS. 2 A and 2B are diagrams explaining a position control system and a pressure control system;

FIGS. 3A and 3B are diagrams showing an example of an operation of the conventional press working apparatus;

FIG. 4 is a diagram showing an example of an inclination correction process by a numerical controller;

FIG. 5 is a diagram showing a detection process of motor positions by a state detection unit;

FIG. 6 is a diagram showing a calculation process of correction gains by a correction gain calculation unit;

FIG. 7 is a diagram showing a calculation process of a correcting pressure by a correction command unit;

FIG. 8 is a diagram showing an example of an operation of the numerical controller;

FIG. 9 is a diagram showing an example of an operation of the numerical controller;

FIG. 10 is a block diagram showing a configuration of the numerical controller; and

FIG. 11 is a flow chart showing an operation of the numerical controller.

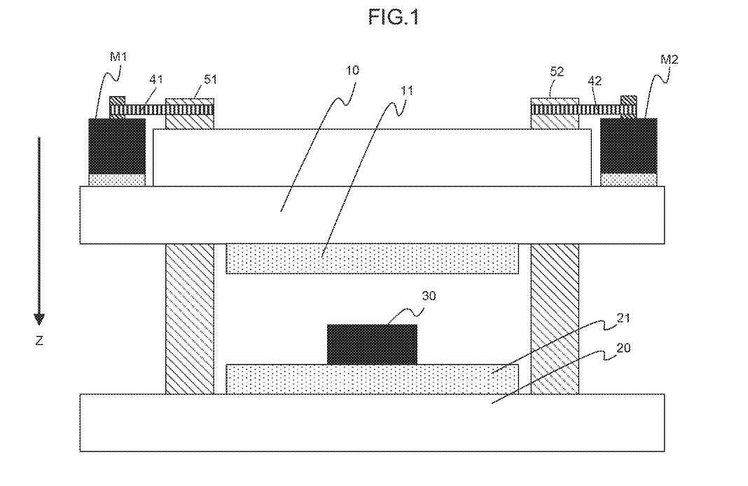

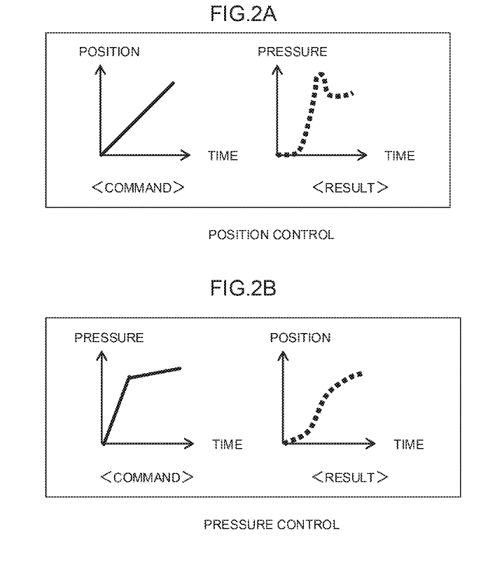

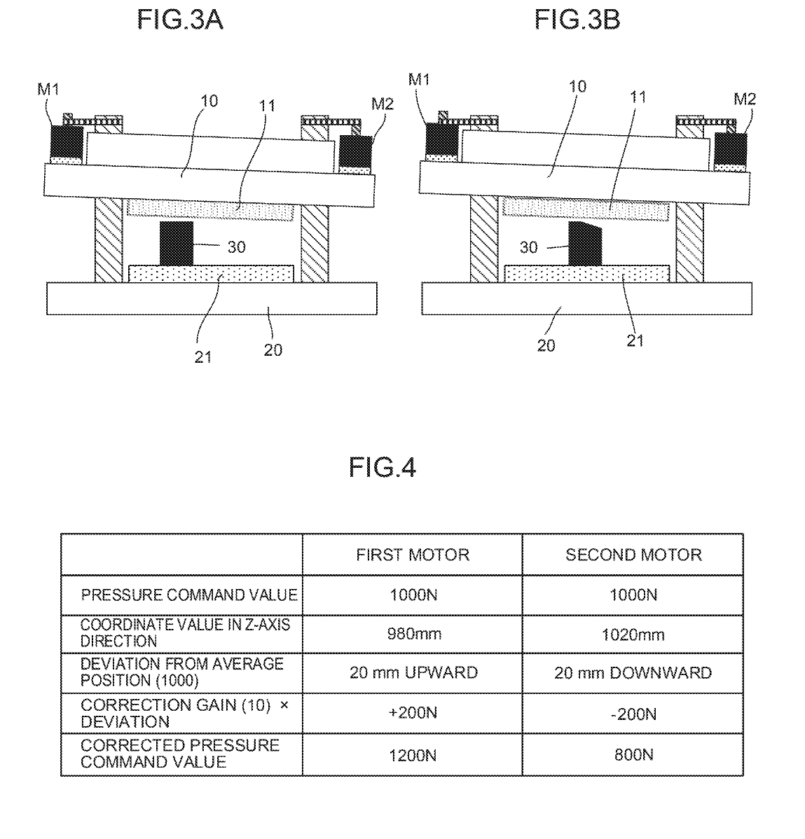

### DETAILED DESCRIPTION OF THE PREFERRED EMBODIMENTS

A configuration of a numerical controller 100 according to embodiments of the present invention is explained with reference to FIG. 10.

The numerical controller 100 is an apparatus that controls a drive apparatus and is configured to drive a first motor and a second motor according to pressure command values to move an upper table up and down, that is, in a Z-axis direction. In the embodiments, the downward direction, that is, the Z-axis direction, is a positive driving direction. The numerical controller 100 includes a state detection unit 110, a correction command unit 120, a correction gain calculation unit 130, and a correction gain storage unit 140. The numerical controller 100 typically includes a central processing unit (CPU), a storage device, and an input-output device, and the CPU executes a predetermined program to realize the state detection unit 110, the correction command unit 120, the correction gain calculation unit 130, and the correction gain storage unit 140.

The state detection unit 110 executes a process of detecting a deviation in positions of a plurality of motors. The motors are also provided with position detectors, and position information of the motors can be acquired in the pressure control. The state detection unit 110 acquires coordinate values of the plurality of motors at any time or every certain time and obtains a difference between the coordinate values to detect a deviation.

The correction command unit 120 executes a process of correcting pressure command values of the motors to eliminate an inclination of the table. The correction command unit 120 determines that the upper table is inclined when an amount of deviation detected by the state detection unit 110 exceeds a predetermined threshold and drives the motors based on new pressure command values (referred to as correcting pressures) obtained by using correction gains described later to correct original pressure command values of the first and second motors. In this way, the inclination of the upper table is corrected to recover the parallel state of the upper table and a lower table. A specific calculation method of the correcting pressures will be described later.

The correction gain calculation unit 130 executes a process of calculating coefficients, that is, the correction gains, for the correction command unit 120 to correct the pressure command values. The correction gain calculation unit 130 calculates the correction gains based on correlations between the coordinate values and the pressures. In other words, the correction gains are coefficients indicating amounts of change in positions with respect to amounts of pressure applied. In the embodiments, the correction gain calculation unit 130 calculates the correction gains based on motions of the motors just before the correction command unit 120 corrects the pressure command values.

The correction gain storage unit 140 stores the correction gains calculated by the correction gain calculation unit 130. Note that the correction gain storage unit 140 may store correction gains manually set through input means (not shown) instead of the correction gains calculated by the correction gain calculation unit 130.

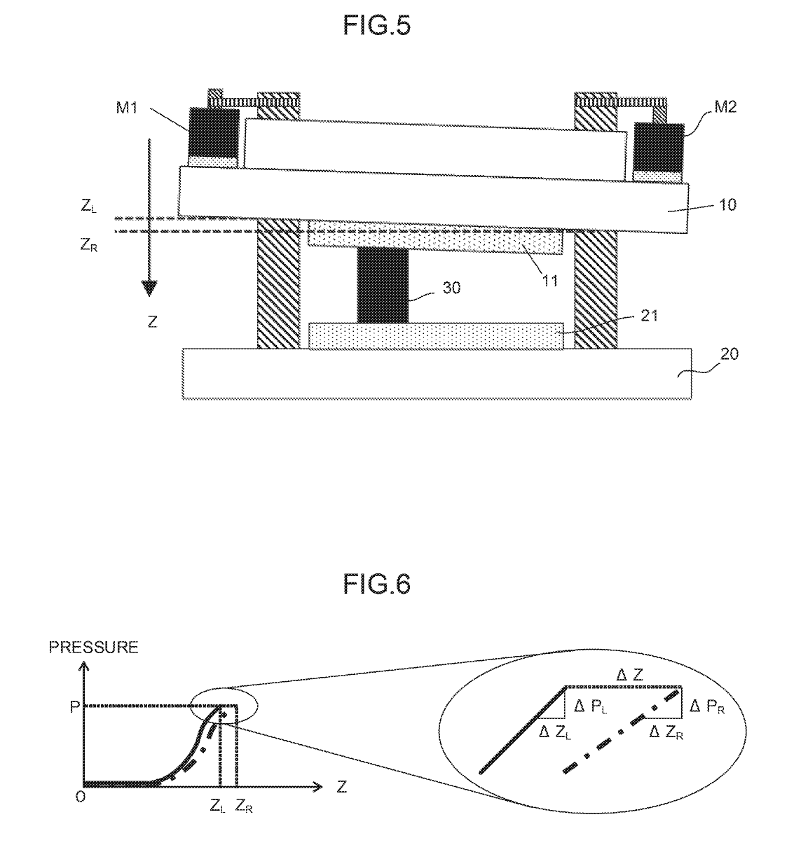

A method of calculating the correction gains by the correction gain calculation unit 130 will be specifically described with reference to FIGS. 5 and 6. In FIG. 5, Z_{L}, indicates a coordinate value of a first motor M1 in the Z-axis direction and Z_{R} indicates a coordinate value of a second motor M2 in the Z-axis direction, which are detected by the state detection unit 110 at a certain point. FIG. 6 shows relationships between the coordinate values and the pressures, up to the coordinate values Z_{L} and Z_{R}. A solid line of FIG. 6 indicates the relationship between the coordinate value and the pressure in the first motor M1, and a dot-dashed line indicates the relationship between the coordinate value and the pressure in the second motor M2.

As shown in FIG. 6, although the relationship between the coordinate value and the pressure is often not linear, according to the present embodiments, the correction gain calculation unit 130 approximates the relationships between the coordinate values and the pressures just before the detection of the coordinate values Z_{L} and Z_{R} by straight lines and obtains the correction gains based on the straight lines. Usually, when the deviation to be modified is a minor deviation of about several mm, the correction gains obtained by the approximate calculation can be used to make the correction without a practical problem. A correction gain G_{L} of the first motor M1 and a correction gain G_{R} of the second motor M2 (unit: N/mm) can be obtained by the following expressions.

G_{L}=(ΔP_{L}/ΔZ_{L}) (1)

G_{R}=(ΔP_{R}/ΔZ_{R}) (2)

Here, ΔP_{L} and ΔP_{R} indicate pressure changes per unit time of the first motor M1 and the second motor M2 just before the detection of the coordinate values Z_{L} and Z_{R}, and ΔZ_{L} and ΔZ_{R} indicate position changes per unit time of the first motor M1 and the second motor M2 just before the detection of the coordinate values Z_{L} and Z_{R}.

In this way, the numerical controller 100 basically carries out pressure control and usually drives the plurality of motors M1 and M2 by the same power. When the numerical controller 100 detects that the tables 10 and 20 are not parallel with each other, the numerical controller 100 uses the correction gains to adjust the power balance of the plurality of motors M1 and M2 to eliminate the inclinations of the tables 10 and 20.

### FIRST EMBODIMENT

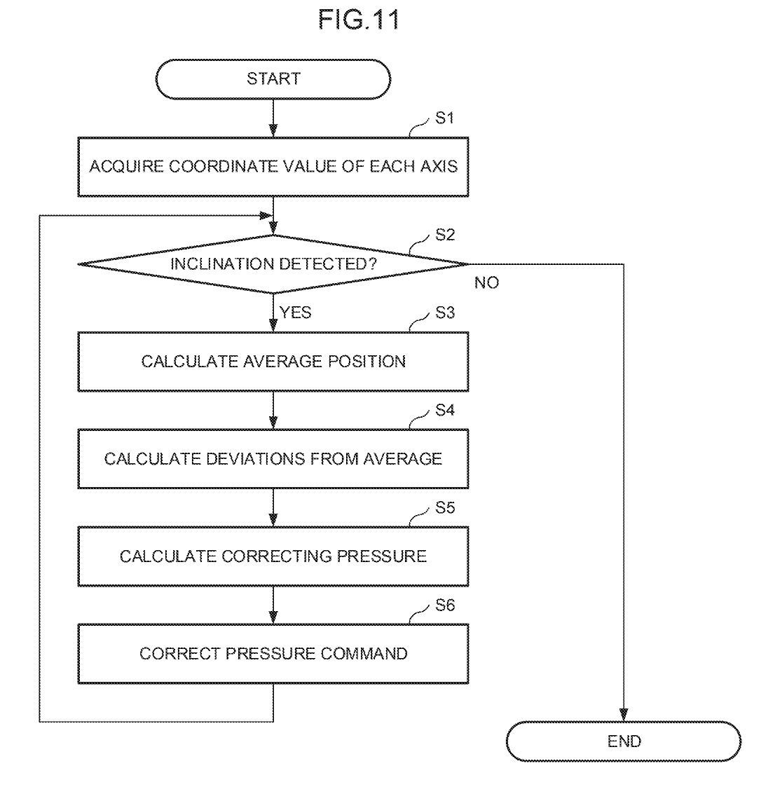

A most typical operation of the numerical controller 100 will be described with reference to a flow chart of FIG. 11 and a table of FIG. 4. The operation will be described below according to the steps.

Step S1: The state detection unit 110 acquires the coordinate values Z_{L} and Z_{R} of the first motor M1 and the second motor M2 in the Z-axis direction every certain time. Preferably, the state detection unit 110 acquires pressure values from force sensors provided on the first motor M1 and the second motor M2, in addition to acquiring the coordinate values of the first motor M1 and the second motor M2. The state detection unit 110 saves the detected coordinate values and pressure values of the first motor M1 and the second motor M2 of the last two times. The coordinate values and the pressure values saved here are used in step S5. Note that the correction gain calculation unit 130 may detect and save the pressure values.

Step S2: The state detection unit 110 calculates the difference between the coordinate values of the motors, and if the difference exceeds a preset threshold, the state detection unit 110 causes the correction command unit 120 to carry out the processes in step S2 and subsequent steps. On the other hand, if the difference is equal to or smaller than the threshold, the process ends.

As shown in FIG. 4, it is assumed that the coordinate value of the first motor M1 in the Z-axis direction is 980 mm, and the coordinate value of the second motor M2 in the Z-axis direction is 1020 mm. Assuming that the threshold is 1 mm, the difference of 40 mm between the coordinate values of the motors exceeds the threshold, and the processes in step S2 and subsequent steps are carried out.

Step S3: The correction command unit 120 calculates an average of the coordinate values of the first motor M1 and the second motor M2 in the Z-axis direction. In the example of FIG. 4, the coordinate value of the first motor M1 in the Z-axis direction is 980 mm, and the coordinate value of the second motor M2 in the Z-axis direction is 1020 mm. Therefore, the average position is 1000 mm.

Step S4: The correction command unit 120 calculates differences between the coordinate values of the first motor M1 and the second motor M2 in the Z-axis direction and the average position calculated in step S3.

In the example of FIG. 4, the deviation of the first motor M1 from the average position is 20 mm upward (−20 mm in the Z-axis direction), and the deviation of the second motor M2 from the average position is 20 mm downward (+20 mm in the Z-axis direction).

Step S5: The correction gain calculation unit 130 uses the coordinate values and the pressure values of the first motor M1 and the second motor M2 in the Z-axis direction of the last two times saved in step S1 to calculate the correction gain G_{L} of the first motor M1 and the correction gain G_{R} of the second motor M2 according to Expression (1) and Expression (2). In the example of FIG. 4, the correction gains are 10.

The correction gain storage unit 140 stores the correction gains G_{L} and G_{R} calculated by the correction gain calculation unit 130. Note that process in step S5 can be skipped if the correction gain storage unit 140 stores correction gains set in advance.

The correction command unit 120 uses the correction gains stored in the correction gain storage unit 140 to calculate the correcting pressures. In the present embodiment, the correcting pressures are the same for the first motor M1 and the second motor M2. More specifically, the pressure of the motor advancing in the Z-axis direction (second motor M2 in FIG. 5) is weakened by P, and the pressure of the delayed motor (first motor M1 in FIG. 5) is increased by P. In this way, while the pressure balance between the motors is changed, the total pressure is not changed.

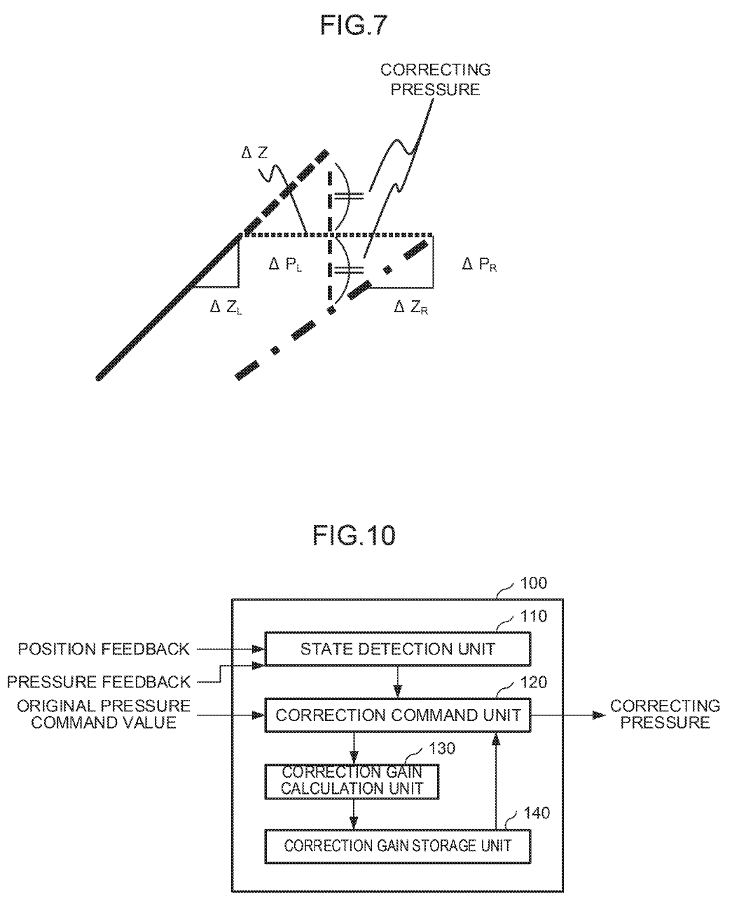

Here, a calculation method of the correcting pressure according to the present embodiment will be described with reference to FIG. 7. The amount of movement of the first motor M1 necessary for correcting the deviation can be obtained by the following expression.

Amount of movement of first motor M1=ΔZ×(G_{R}÷(G_{L}+G_{R}))

The correcting pressure necessary for realizing the amount of movement of the first motor M1 can be obtained by multiplying the correction gain of the first motor M1 by the amount of movement of the first motor M1.

Correcting pressure of the first motor M1=ΔZ×((G_{L}×G_{R})÷(G_{L}+G_{R}))

The correcting pressure of the second motor M2 can be similarly obtained, and thus,

Correcting pressure of the second motor M2=ΔZ×((G_{L}×G_{R})÷(G_{L}+G_{R})) (3)

In the example of FIG. 4, the correcting pressure of the first motor M1 is +200 N, and the correcting pressure of the second motor M2 is −200 N.

Another example will be used for further description. It is assumed that the coordinate value Z_{L} of the first motor M1 is 985 mm, and the coordinate value Z_{R} of the second motor M2 is 1015 mm. It is also assumed that the correction gain G_{L} of the first motor M1 is 10 N/mm, and the correction gain G_{R} of the second motor M2 is 5 N/mm. In this case, the correcting pressure can be obtained by the above Expression (3).

Correcting Pressure =(1015−985)×((10×5)÷(10+5))=100 N

Step S6: The correction command unit 120 corrects the pressure command values by using the correcting pressure to generate new pressure command values (referred to as correcting pressure command values) and outputs the corrected output values to the motors M1 and M2. More specifically, the correction command unit 120 subtracts the correcting pressure from the pressure command value of the motor advancing in the Z-axis direction and adds the correcting pressure to the pressure command value of the delayed motor.

In the example of FIG. 4, the correcting pressure command value of the first motor M1 is 1000 N+200 N=1200 N, and the correcting pressure command value of the second motor M2 is 1000 N−200 N=800 N.

Another example will be described. It is assumed that the coordinate value Z_{L} of the first motor M1 is 985 mm, and the coordinate value Z_{R} of the second motor M2 is 1015 mm. It is also assumed that the pressure command value of the first motor M1 and the pressure command value of the second motor M2 are both 1000 N, and the correcting pressure is 100 N. In this case, the correcting pressure command value of the first motor M1 is 1000 N+100 N=1100 N, and the correcting pressure command value of the second motor M2 is 1000 N−100 N=900 N.

When the process is finished, the correction command unit 120 proceeds to step S2 again and determines whether the inclination of the table 10 is eliminated or not. If the inclination of the table 10 is eliminated, the correction command unit 120 ends the process and then continues to check the inclination of the table 10 every certain time. If the inclination of the table 10 is not eliminated, the correction command unit 120 executes the processes in step S3 and subsequent steps again and further corrects the inclination. In this way, the inclination correction process can be periodically or continually repeated to eliminate the inclination of the upper table 10 and quickly recover the parallel state of the tables.

According to the present embodiment, if the correction command unit 120 detects the inclination of the table based on the difference in the position information between the plurality of motors, the correction command unit 120 uses the correction gains calculated by the correction gain calculation unit 130 or the correction gains set in advance to calculate the correcting pressures of the plurality of motors. In this case, the absolute values of the correcting pressures of the plurality of motors are the same value. As a result, the inclination of the table can be eliminated to reduce the machining failure rate in the drive apparatus such as a press working apparatus. The reduction in the lifetime of dies used in press working and the like can also be prevented. Furthermore, abnormal sound and abnormal vibration during the drive caused by the inclination of the table can be prevented, and the reduction in the lifetime of the machine can be prevented.

### SECOND EMBODIMENT

In the first embodiment, the correction command unit 120 makes the correction in a manner such that the total pressure of the first motor M1 and the second motor M2 is kept same before and after the correction. In a second embodiment, the correction command unit 120 does not change the pressure command value of the motor advancing in the Z-axis direction and makes a correction by increasing the pressure command value of the delayed motor. The correction method is suitable for, for example, a material which significantly tends to spring back (or material which tends to return to its original shape when a workpiece is released from a load) or a material that completely plastically deforms. If the correction of reducing the pressure is made as in the first embodiment in such a material, the workpiece may be deformed or may jump up. The present embodiment can prevent the phenomenon.

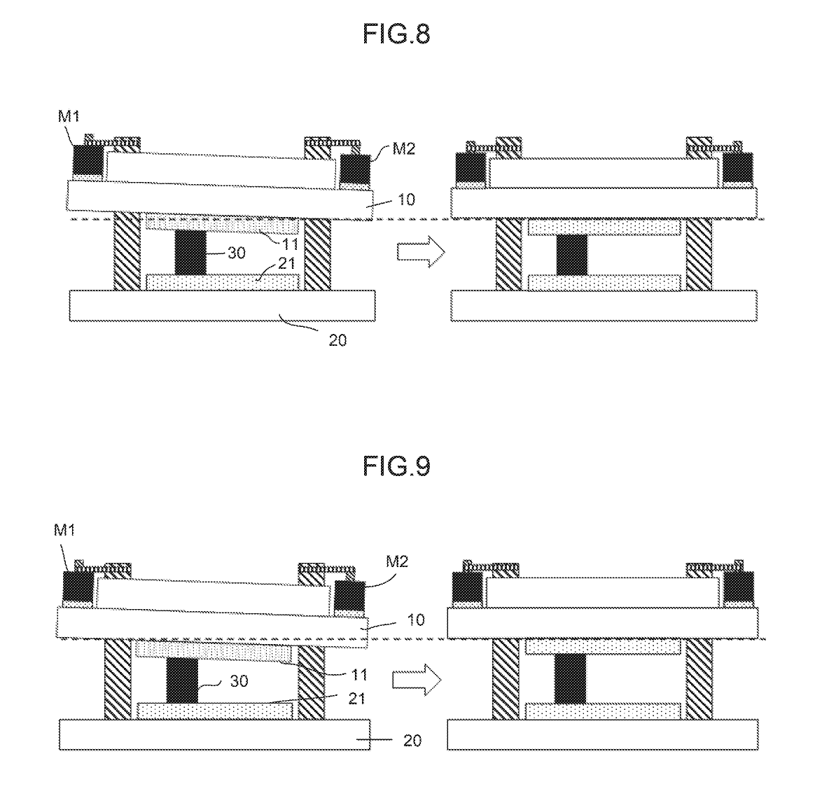

An operation of the numerical controller 100 according to the present embodiment will be described with reference to FIG. 8.

It is assumed that the second motor M2 advances in the Z-axis direction, and the first motor M1 is delayed as shown in the left side of FIG. 8. When the original pressure command values of the first motor M1 and the second motor M2 are 1000 N, the correction command unit 120 increases only the correcting pressure command value of the first motor M1 delayed in the Z-axis direction to, for example, 1200 N. Although the correction gains and the correcting pressures can be calculated in the same way as in the first embodiment, the correction command unit 120 can add the absolute values of the correcting pressures of all the motors M1 and M2 and set the total value as the correcting pressure for the first motor M1. Alternatively, the correction command unit 120 may output the correcting pressure command value only for the first motor M1.

### THIRD EMBODIMENT

In a third embodiment, the correction command unit 120 makes a correction by reducing the pressure command value of the motor advancing in the Z-axis direction and keeping the pressure command value of the delayed motor as it is. The correction method is suitable for, for example, a delicate material in which a machining failure easily occurs due to a strong load.

An operation of the numerical controller 100 according to the present embodiment will be described with reference to FIG. 9.

It is assumed that the second motor M2 advances in the Z-axis direction, and the first motor M1 is delayed as shown in the left side of FIG. 9. Assuming that the original pressure command values of the first motor M1 and the second motor M2 are 1000 N, the correction command unit 120 reduces only the correcting pressure command value of the second motor M2 advancing in the Z-axis direction to, for example, 800 N. Although the correction gains and the correcting pressures can be calculated in the same way as in the first embodiment, the correction command unit 120 can add the absolute values of the correcting pressures of all the motors M1 and M2 and set the total value as the correcting pressure for the second motor M2. Alternatively, the correction command unit 120 may output the correcting pressure command value only for the second motor M2.

The present invention is not limited to the embodiments, and changes can be appropriately made without departing from the scope of the present invention. Any constituent elements of the embodiments can be modified, or any constituent elements of the embodiments can be eliminated in the present invention within the scope of the invention. For example, although the number of motors is mainly two in the description of the embodiments, the present invention can also be applied when the number of motors is three or more. More specifically, the deviation from the average position can be calculated for each motor, and the correction gain and the correcting pressure can be calculated based on the deviation to eliminate the inclination in the drive apparatus including three or more motors.

Although the correction command unit 120 sets the same correcting pressure for the plurality of motors or sets one of the correcting pressures to 0 in the embodiments, the correcting pressures may be distributed to the plurality of motors on a gradual basis. For example, when the first motor advances in the Z direction, the absolute value of the correcting pressure for reducing the pressure command value of the first motor may be a value smaller than the absolute value of the correcting pressure for increasing the correcting pressure of the second motor. In this case, the problem of the first embodiment described in the second and third embodiments can be prevented, and the inclination of the table can be eliminated in a shorter time than in the second and third embodiments.

1. A numerical controller that performs pressure control based on a pressure command and controls a drive apparatus comprising a table driven by at least two motors, a first motor and a second motor, the numerical controller comprising:
a state detection unit that detects respective positions of the first motor and the second motor;
a correction gain storage unit that stores, for each of the first motor and the second motor, a correction gain indicating a relationship between pressure and position; and
a correction command unit that calculates, when the positions of the first motor and the second motor are deviated, a correcting pressure based on the correction gains to correct a pressure command values of each of the first motor and the second motor based on the correcting pressure.

2. The numerical controller according to claim 1, further comprising
a correction gain calculation unit that calculates the correction gains.

3. The numerical controller according to claim 1, wherein
when the position of the second motor advances more in a driving direction than the position of the first motor, the correction command unit makes a correction by increasing the pressure command value of the first motor and reducing the pressure command value of the second motor.

4. The numerical controller according to claim 1, wherein
when the position of the second motor advances more in the driving direction than the position of the first motor, the correction command unit makes a correction by increasing only the pressure command value of the first motor and keeping the pressure command value of the second motor.

5. The numerical controller according to claim 1, wherein
when the position of the second motor advances more in the driving direction than the position of the first motor, the correction command unit makes a correction by keeping the pressure command value of the first motor and reducing only the pressure command value of the second motor.
